(19) United States
(12) Patent Application Publication
(10) Pub. No.: US 2020/0020339 A1
(43) Pub. Date: Jan. 16, 2020

(54) ARTIFICIAL INTELLIGENCE ELECTRONIC DEVICE

(71) Applicant: LG ELECTRONICS INC., Seoul (KR)

(72) Inventor: Jonghoon Chae, Seoul (KR)

(73) Assignee: LG ELECTRONICS INC., Seoul (KR)

(21) Appl. No.: 16/584,112

(22) Filed: Sep. 26, 2019

(30) Foreign Application Priority Data
Aug. 29, 2019 (KR) 10-2019-0106826

(51) Int. Cl. G10L 15/22; G10L 15/18; G10L 15/28; G06N 20/00; G06N 3/08

(52) U.S. Cl. CPC G10L 15/22; G10L 15/1815; G10L 2015/223; G06N 20/00; G06N 3/08; G10L 15/28

(57) ABSTRACT

Disclosed is an artificial intelligence electronic device including an input unit configured to receive speech input from a user, a communication unit configured to communicate with a plurality of other artificial intelligence electronic devices, and a processor configured to determine a device which will perform a function corresponding to the speech input, when the artificial intelligence electronic device and one or more other artificial intelligence electronic devices receive the speech input, and perform the function corresponding to the speech input when the device which will perform the function corresponding to the speech input is the artificial intelligence electronic device.

### CROSS-REFERENCE TO RELATED APPLICATIONS

This application claims priority to Korean Patent Application No. 10-2019-0106826 filed on Aug. 29, 2019 in Korea, the entire contents of which is hereby incorporated by reference in its entirety.

### BACKGROUND

The present invention relates to an artificial intelligence electronic device capable of determining an artificial intelligence electronic device which will perform a function when a plurality of artificial intelligence electronic devices receives speech input of a user.

Artificial intelligence is a field of computer engineering and information technology for researching a method of enabling a computer to do thinking, learning and self-development that can be done by human intelligence, and means that a computer can imitate a human intelligent action.

In addition, artificial intelligence does not exist in itself but has many direct and indirect associations with the other fields of computer science. In particular, today, attempts to introduce artificial intelligent elements to various fields of information technology to deal with issues of the fields have been actively made.

Meanwhile, technology of recognizing and learning a surrounding situation using artificial intelligence and providing information desired by a user in a desired form or performing a function or operation desired by the user is actively being studied.

Meanwhile, electronic devices for performing various operations and functions through speech recognition by combining user's speech recognition and context awareness technology are increasing. Such electronic devices may be referred to as speech agents.

Meanwhile, there is a plurality of electronic devices for performing the function of the speech agent in the home. That is, there is a plurality of electronic devices which will perform an function with respect to user's speech input (user's request).

Accordingly, the user may request a function from one electronic device, but a plurality of electronic devices may perform the function. Alternatively, the user may request a function from a specific electronic device, but another electronic device may perform the function.

### SUMMARY

An object of the present invention is to an artificial intelligence electronic device capable of determining an artificial intelligence electronic device which will perform a function when a plurality of artificial intelligence electronic devices receives speech input of a user.

An artificial intelligence electronic device according to an embodiment of the present invention includes an input unit configured to receive speech input from a user, a communication unit configured to communicate with a plurality of other artificial intelligence electronic devices, and a processor configured to determine a device which will perform a function corresponding to the speech input, when the artificial intelligence electronic device and one or more other artificial intelligence electronic devices receive the speech input, and perform the function corresponding to the speech input when the device which will perform the function corresponding to the speech input is the artificial intelligence electronic device.

### BRIEF DESCRIPTION OF THE DRAWINGS

FIG. 1 is a diagram showing an artificial intelligence (AI) device 100 according to an embodiment of the present invention.

FIG. 2 is a diagram showing an AI server 200 according to an embodiment of the present invention.

FIG. 3 is a diagram showing an AI system 1 according to an embodiment of the present invention.

FIG. 4 is a diagram showing a plurality of electronic devices according to another embodiment of the present invention.

FIG. 5 is a view showing a use environment of a plurality of electronic devices according to an embodiment of the present invention.

FIG. 6 is a flowchart illustrating a method of operating an artificial intelligence electronic device according to an embodiment of the present invention.

FIG. 7 is a view illustrating a method of operating a plurality of electronic devices according to an embodiment of the present invention.

FIG. 8 is a view illustrating an operation method when a device which will perform a function corresponding to speech input is another electronic device according to an embodiment of the present invention.

FIG. 9 is a view illustrating an operation method when speech input corresponds to a unique role of another electronic device but the other electronic device does not receive speech input according to an embodiment of the present invention.

FIG. 10 is a view illustrating a method of determining a device which will acquire an intent.

FIG. 11 is a view illustrating another method of determining a device which will acquire an intent.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the invention in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct response (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

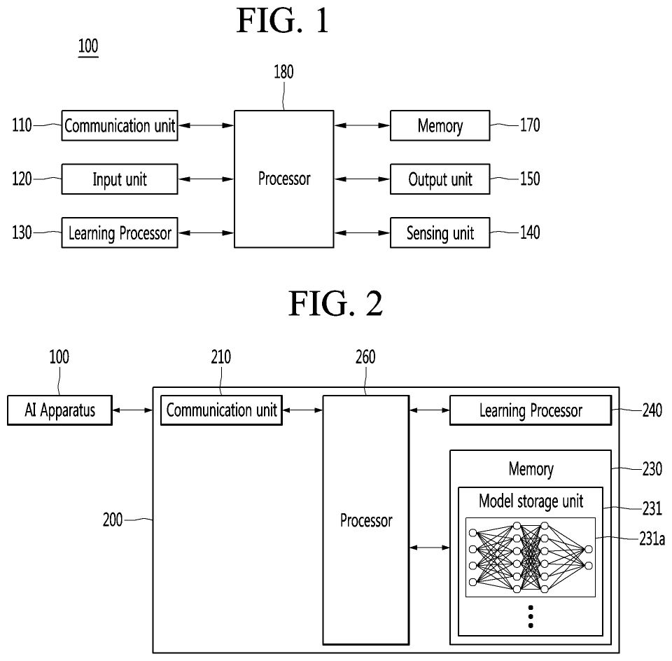

FIG. 1 illustrates an AI device 100 according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intent information for the user input and may determine the user's requirements based on the acquired intent information.

The processor 180 may acquire the intent information corresponding to the user input by using at least one of a speech to text (STT) engine for converting speech input into a text string or a natural language processing (NLP) engine for acquiring intent information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

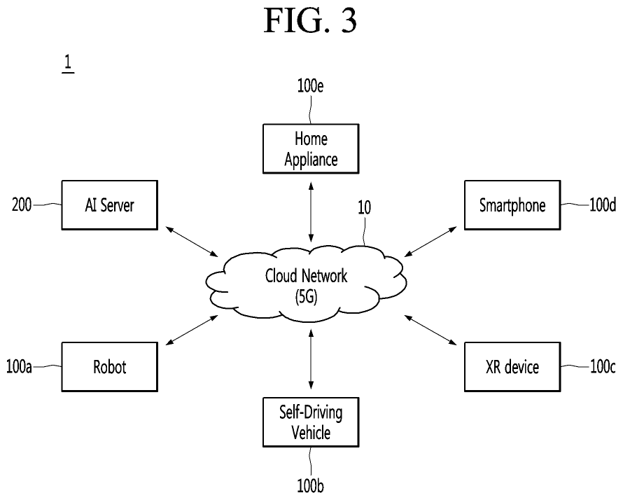

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intent information of the interaction due to the user's operation or speech utterance, and may determine the response based on the acquired intent information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intent information of the interaction due to the user's operation or speech utterance, and may determine the response based on the acquired intent information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

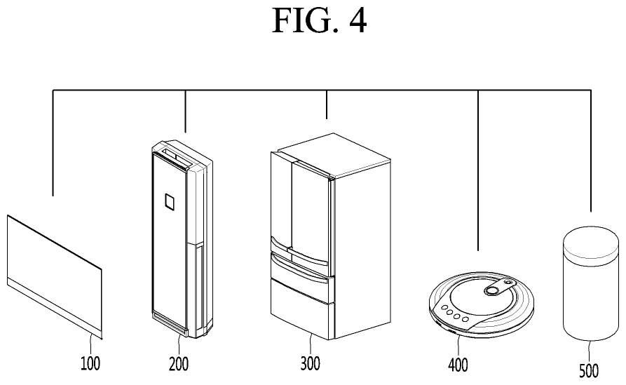

FIG. 4 is a diagram showing a plurality of electronic devices according to another embodiment of the present invention.

A first electronic device 100 may include the configuration of the AI device 100 described with reference to FIG. 1 and may perform the function of the AI device 100. Accordingly, the term “first electronic device 100” may be used interchangeably with the term “AI device 100”.

In addition, the other electronic devices 200, 300, 400 and 500 may include the configuration of the AI device 100 described with reference to FIG. 1 and may perform the function of the AI device 100.

In addition, in this specification, the term “electronic device” may be used interchangeably with the term “artificial intelligence electronic device”

The plurality of electronic devices 100, 200, 300, 400 and 500 may communicate with each other.

Specifically, each of the plurality of electronic devices may include a communication unit. The communication unit may provide an interface for connecting the electronic device to a wired/wireless network including the Internet network. The communication unit may transmit or receive data to or from another electronic device through a connected network or another network linked to the connected network.

The communication unit may support short range communication using at least one of Bluetooth™, RFID (Radio Frequency Identification), Infrared Data Association (IrDA), UWB (Ultra Wideband), ZigBee, NFC (Near Field Communication), Wi-Fi (Wireless-Fidelity), Wi-Fi Direct or Wireless USB (Wireless Universal Serial Bus).

The communication unit may support wireless communication between an electronic device and another electronic device through wireless area networks.

The plurality of electronic devices 100, 200, 300, 400 and 500 may be located in a specific range. Accordingly, at least two of the plurality of electronic devices may receive and recognize the same speech input of a user.

In addition, the plurality of electronic devices 100, 200, 300, 400 and 500 may be located together at a specific place. For example, the plurality of electronic devices 100, 200, 300, 400 and 500 may be a TV, an air conditioner, a refrigerator, a cleaner and a speaker installed in one house. In addition, at least two of the plurality of electronic devices may simultaneously receive and recognize the same speech input of the user.

Each of the plurality of electronic devices 100, 200, 300, 400 and 500 may have a speech recognition model installed therein.

Specifically, speech recognition means that a speech signal is converted into text or a linguistic semantic content, by interpreting the speech signal and combining the speech signal with a patterned database.

In speech recognition technology, a speech recognition model analyzes received speech data, extracts features, measures similarity with a previously collected speech model database, and converts the most similar one into text or a command.

When the speech input of the user is input to the speech recognition model, the speech recognition model may output a result of recognizing the speech input.

Meanwhile, the speech recognition model may perform a speech recognition function. Specifically, the speech recognition model may extract language information included in the speech input and change the extracted language information into text information.

In addition, the speech recognition model may perform a speech understanding function. Specifically, the speech recognition model may determine language information of text information by grasping the syntax structure of the text information.

In addition, the speech recognition model may output an intent corresponding to the speech input.

Specifically, the speech recognition model may acquire the intent corresponding to the speech input using at least one of a speech-to-text (STT) engine for converting speech input into text or a natural language processing (NLP) engine for acquiring an intent of a natural language.

A method and operation of generating a speech recognition model are well known and detailed descriptions thereof will be omitted.

Meanwhile, each the plurality of electronic devices 100, 200, 300, 400 and 500 may include a function performing unit for performing a unique function.

The function performing unit may perform the unique operation of each electronic device.

For example, when the electronic device is a TV, the function performing unit may display an image and output sound. In addition, the function performing unit may perform operations such as turn-on, turn-off, channel change, volume change, etc.

In another example, when the electronic device is an air conditioner, the function performing unit may perform operations such as cooling, dehumidification, air purification, etc. In addition, the function performing unit may perform operations such as turn-on, turn-off, temperature change, mode change, etc.

Meanwhile, the function performing unit may perform a function corresponding to the speech input of the user.

Here, the function corresponding to the speech input may be operation according to a user request included in the speech input.

For example, when the electronic device is a TV and speech input is “Turn it off”, the function performing unit may turn off the TV.

In another example, when the electronic device is an air conditioner and speech input is “Make it cooler”, the function performing unit may increase the volume of discharged air or decrease a temperature.

In addition, the function corresponding to the speech input may be a response to a user's inquiry included in the speech input.

In another example, when the electronic device is a refrigerator and speech input is “How is today's weather?”, the function performing unit may output (display or audibly output) today's weather information.

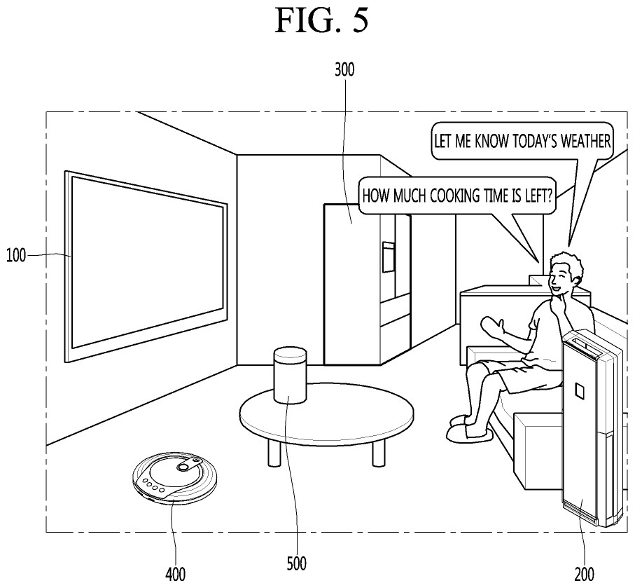

FIG. 5 is a view showing a use environment of a plurality of electronic devices according to an embodiment of the present invention.

The plurality of electronic devices 100, 200, 300, 400 and 500 may be located together at a specific place. For example, the plurality of electronic devices 100, 200, 300, 400 and 500 may be a TV, an air conditioner, a refrigerator, a cleaner and a speaker installed in one house.

Meanwhile, assume that the user utters speech “Let me know today's weather”.

When the first to fourth electronic devices 100, 200, 300 and 400 of the plurality of electronic devices 100, 200, 300, 400 and 500 receive speech input “Let me know today's weather”, the first to fourth electronic devices 100, 200, 300 and 400 output a response to the user's inquiry (for example, today's weather in Seoul is sunny and a temperature is 26° C.)

That is, since a plurality of electronic devices is capable of outputting the response to the user's inquiry, the plurality of electronic devices may output a plurality of responses.

In addition, assume that the user utters speech “How much cooking time is left?”. In this case, since the user requests a response from a cooking device, the cooking device which has received the speech input outputs a response “20 minutes are left”. However, when the TV receives the speech input “How much cooking time is left?”, the TV fails to recognize the speech and thus output a response “This is a function that I cannot perform.

In addition, assume that the user utters speech “How much cooking time is left?”. In this case, since the user requests a response from the cooking device, the cooking device which has received the speech input should output the response “20 minutes are left”. However, when the user utters the speech at a place far from the cooking device, the cooking device may not receive the speech input and thus cannot output the response. In this specification, the speech input being not received may mean that the speech signal is not received through the speaker or the speech signal is received through the speaker but speech recognition fails.

Accordingly, there is a need for a method of solving such problems.

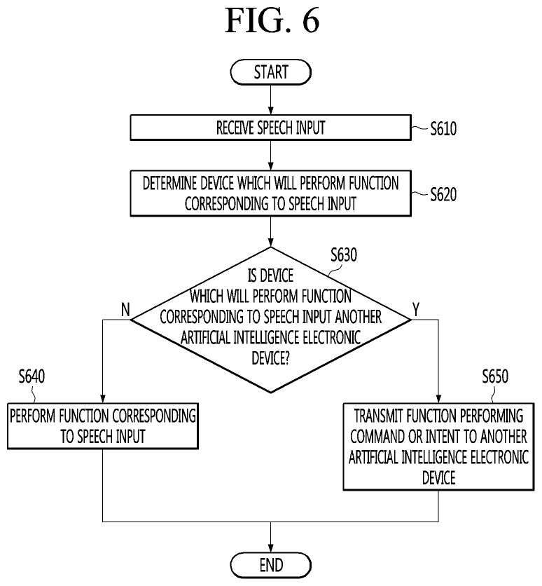

FIG. 6 is a flowchart illustrating a method of operating an artificial intelligence electronic device according to an embodiment of the present invention.

In FIG. 6, the method of operating the artificial intelligence electronic device according to the embodiment of the present invention may include step (S610) of receiving speech input from a user, step (S620) of determining a device which will perform a function corresponding to the speech input when the artificial intelligence electronic device and one or more other artificial intelligence electronic devices receive the speech input, steps S630 and S640 of performing the function corresponding to the speech input when the device which will perform the function corresponding to the speech input is the artificial intelligence electronic device, and steps S630 and S650 of transmitting a function performing command or a recognition result to a second artificial intelligence electronic device when the device which will perform the function corresponding to the speech input is the second artificial intelligence electronic device among one or more artificial intelligence electronic devices.

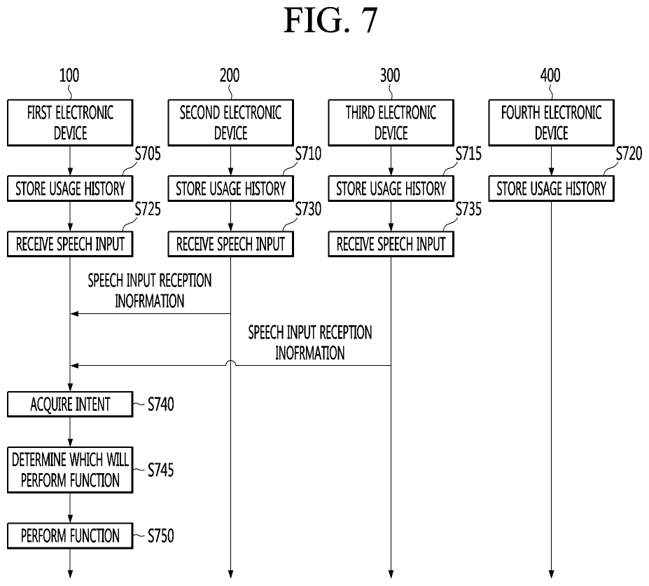

FIG. 7 is a view illustrating a method of operating a plurality of electronic devices according to an embodiment of the present invention.

Assume that the plurality of electronic devices includes a first electronic device, a second electronic device, a third electronic device and a fourth electronic device.

Hereinafter, the description of the first electronic device is applicable to the other electronic devices.

The plurality of electronic devices may store respective usage histories (S705, S710, S715 and S720).

For example, the first electronic device will be described.

The processor of the first electronic device may store the usage history of the first electronic device.

Here, the usage history of the first electronic device may include at least one of the speech input received by the first electronic device or a function performed by the first electronic device in correspondence with the speech input received by the first electronic device.

For example, when the first electronic device receives the speech input “How is today's weather?” and the first electronic device outputs the response “Today's weather is sunny”, the processor of the first electronic device may store at least one of the speech input “How is today's weather?” or the response “Today's weather is sunny” in a memory.

Meanwhile, the respective usage histories of the plurality of electronic devices may be shared with one another.

For example, the first electronic device may communicate with a plurality of other artificial intelligence electronic devices and the usage history of the first electronic device may be transmitted to the second to fourth electronic devices. In another example, the second electronic device may transmit the usage history of the second electronic device to the first, third and fourth electronic devices.

Meanwhile, a role may be set in each of the plurality of electronic devices.

Here, the role may include a common role commonly assigned to the plurality of artificial intelligence electronic devices and a unique role solely assigned to one of the plurality of artificial intelligence electronic devices.

Meanwhile, the role may be set in each of the plurality of electronic devices based on the usage histories of the plurality of electronic devices.

For example, the first electronic device will be described.

The processor of the first electronic device may set the unique role and the common role of the first electronic device using the usage histories of the plurality of electronic devices.

For example, when only the first electronic device outputs the response to “How much cooking time is left?”, the processor of the first electronic device may set the response to the remaining cooking time as the unique role of the first electronic device.

In another example, when only the first electronic device (the air conditioner) performs operation corresponding to “Decrease the temperature of the air conditioner”, the processor of the first electronic device may set operation of decreasing the temperature of the air conditioner as the unique role of the first electronic device.

In another example, when the first to third electronic devices output the response to “How is today's weather?”, the processor of the first electronic device may set the response to the weather as the common role of the first electronic device.

Meanwhile, the respective roles of the plurality of electronic devices may be shared with one another.

Meanwhile, the respective roles of the plurality of electronic devices may be set based on setting operations of the plurality of electronic devices.

Specifically, information on the setting operations of the plurality of electronic devices may be shared among the plurality of electronic devices.

In addition, the first electronic device may set the role of the first electronic device based on the information on the setting operations of the plurality of electronic devices.

For example, when only the first electronic device (e.g., a cooking device) of the plurality of electronic devices performs cooking operation, the processor of the first electronic device may set the response to the inquiry related to the cooking operation or operation (e.g., setting the temperature of the oven to 200° C.) corresponding to a cooking request (e.g., Set the temperature of the oven to 200° C.) as the unique role of the first electronic device.

In another example, when the first to second electronic devices of the plurality of electronic devices provides the response to the weather, the processor of the first electronic device may set the response to the weather as the common role of the first electronic device. In this case, the second electronic device may also set the response to the weather as the common role of the second electronic device.

Meanwhile, the processor of the first electronic device may determine the roles of the other electronic devices and transmit the determined roles to the other electronic devices.

For example, the processor of the first electronic device may determine the unique role and the common role of the second electronic device, based on the usage histories of the plurality of electronic devices or the setting operations of the plurality of electronic devices. In this case, the processor of the first electronic device may transmit the unique role and the common role of the second electronic device to the second electronic device.

Meanwhile, the processor of the first electronic device may store the roles of the plurality of electronic devices in the memory.

Meanwhile, when the user utters speech, some or all of the plurality of electronic devices may receive the speech input from the user.

For example, the processor of the first electronic device 100 may receive the speech input from the user through an input unit. In addition, the second electronic device 200 and the third electronic device 300 as well as the first electronic device 100 may receive the speech input from the user. Meanwhile, the fourth electronic device 400 may not receive the speech input.

Meanwhile, when the first electronic device 100 and one or more other artificial intelligence electronic devices 200 and 300 receive the speech input, the processor of the first electronic device 100 may determine a device which will perform the function corresponding to the speech input.

Specifically, the processor of the first electronic device 100 may receive speech input reception information indicating that the speech input has been received from the one or more other artificial intelligence electronic devices 200 and 300.

In addition, the processor of the first electronic device 100 may determine a device which will perform the function corresponding to the speech input from among the first electronic device 100 and the one or more other artificial intelligence electronic devices 200 and 300.

In order to determine the device which will perform the function corresponding to the speech input, the processor of the first electronic device 100 may acquire an intent corresponding to the speech input using the speech input.

Specifically, the processor of the first electronic device 100 may input the speech input to the speech recognition model to acquire the intent corresponding to the speech input. In this case, the speech recognition model may output the intent corresponding to the speech input, by performing STT and NLP.

Meanwhile, the processor may acquire the intent corresponding to the speech input using the speech input and context information.

Here, the context information is data used to determine which electronic device the user wants to perform the function, and may include the captured image of the user, sound, a season, a date, a time, location data of the user, and operation data of electronic devices. In addition, the context information may be collected by the first electronic device 100, the other electronic devices 200, 300, 400 and 500 or various sensors disposed in an indoor space.

In addition, the processor of the first electronic device 100 may acquire the intent corresponding to the speech input using the speech input and the context information.

For example, when a user who cooks in a kitchen utters speech “How much time is left?”, the processor may acquire the intent of the user (How much cooking time is left?) using the speech input of the user and the image of cooking in the kitchen.

In another example, when a user watching a TV turns their head and utters speech “Decrease” while looking at an air conditioner, the processor may acquire the intent (decrease the temperature of the air conditioner) of the user based on the speech input of the user and the captured image of the user.

Meanwhile, the processor of the first electronic device 100 may perform the function corresponding to the speech input based on the acquired intent and “the role set in each of the first electronic device 100 and the one or more other electronic devices 200 and 300 which have received the speech input.

Specifically, the processor may determine which of the first electronic device 100 and the one or more other electronic devices 200 and 300 which have received the speech input has a role corresponding to the intent.

In addition, the processor may determine that the device which will perform the function corresponding to the speech input is the first electronic device 100, when the intent corresponds to the role of the first electronic device 100.

Specifically, when the intent corresponds to the unique role of the first electronic device 100, the processor of the first electronic device 100 may determine the first electronic device 100 as the device which will perform the function corresponding to the speech input.

More specifically, the unique role may be the unique role of the first electronic device solely assigned to the first electronic device among the plurality of electronic devices (100, 200, 300, 400). Accordingly, when the intent corresponds to the unique role of the first electronic device 100, the processor of the first electronic device 100 may determine the first electronic device 100 as the device which will perform the function corresponding to the speech input. In addition, the processor of the first electronic device 100 may perform the function corresponding to the speech input (S750).

For example, when the first electronic device 100 is a cooking device and the intent is “Let me know the remaining cooking time”, the processor of the first electronic device 100 may output a response “20 minutes are left”.

In addition, when the intent corresponds to the common role of the first electronic device 100, the processor of the first electronic device 100 may determine the device which will perform the function corresponding to the speech input from among the first electronic device 100 and the one or more other electronic devices 200 and 300.

Specifically, since the common role is commonly assigned to the plurality of electronic devices 100, 200, 300 and 400, the first electronic device 100 and the one or more other electronic devices 200 and 300 may perform the function corresponding to the speech input. Accordingly, the processor of the first electronic device 100 may determine the device which will perform the function corresponding to the speech input from among the first electronic device 100 and the one or more other electronic devices 200 and 300.

In this case, the processor of the first electronic device 100 may acquire distances between the first electronic device 100 and the one or more other electronic devices 200 and 300 and the user.

In this case, the distances between the first electronic device 100 and the one or more other electronic devices 200 and 300 and the user may be acquired by various methods. For example, the processor of the first electronic device 100 may acquire the distances between the first electronic device 100 and the one or more other electronic devices 200 and 300 and the user, based on the captured image of the user. In another example, the processor of the first electronic device 100 may acquire the distances between the first electronic device 100 and the one or more other electronic devices 200 and 300 and the user, based on the levels of the speech input by the first electronic device 100 and the one or more other electronic devices 200 and 300.

In addition, when the intent corresponds to the common role, the processor of the first electronic device 100 may determine a device closest to the user among the first electronic device 100 and the one or more other electronic devices 200 and 300 as the device which will perform the function corresponding to the speech input.

Meanwhile, when the device which will perform the function corresponding to the speech input is the first electronic device, the processor of the first electronic device 100 may perform the function corresponding to the speech input (S750).

Specifically, when the first electronic device 100 is closest to the user among the first electronic device 100 and the one or more other electronic devices 200 and 300, the processor of the first electronic device 100 may perform the function corresponding to the speech input.

For example, when the intent is “How is today's weather?” and the first electronic device 100 is closest to the user, the processor of the first electronic device 100 may output the response “Today's weather is sunny”.

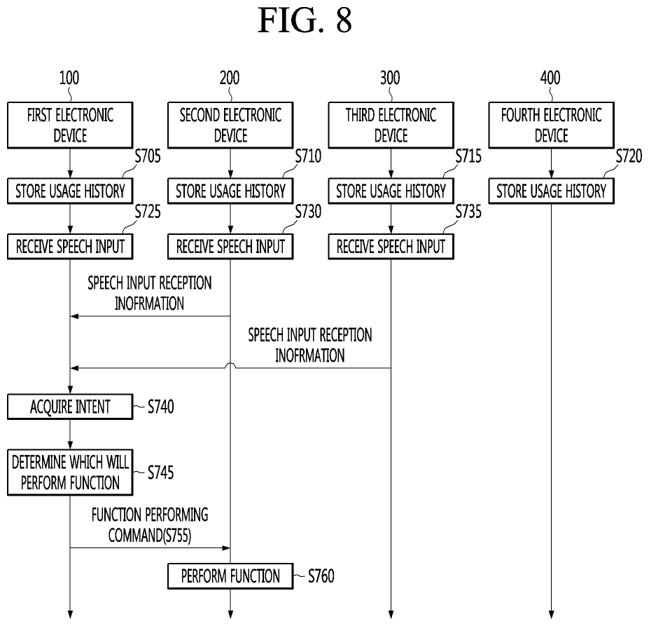

Meanwhile, operation when the device which will perform the function corresponding to the speech input is another electronic device will be described with reference to FIG. 8.

FIG. 8 is a view illustrating an operation method when a device which will perform a function corresponding to speech input is another electronic device according to an embodiment of the present invention.

Assume that the device which will perform the function corresponding to the speech input is the second electronic device 200. The description of the second electronic device 200 is applicable to the other electronic devices.

In addition, the same portion as the above description will be omitted and a portions different from the above description will be described with reference to FIG. 8.

The processor of the first electronic device 100 may determine the device which will perform the function corresponding to the speech input, based on the acquired intent and the role set in each of “the first electronic device 100 and the one or more other electronic devices 200 and 300 which have received the speech input.

Specifically, the processor of the first electronic device 100 may determine which of the first electronic device 100 and the one or more other electronic devices 200 and 300 which have received the speech input has a role corresponding to the intent.

In addition, the processor of the first electronic device 100 may determine that the device which will perform the function corresponding to the speech input is the second electronic device 200, when the intent corresponds to the role of the second electronic device 200.

Specifically, when the intent corresponds to the unique role of the second electronic device 200, the processor of the first electronic device 100 may determine the second electronic device 200 as the device which will perform the function corresponding to the speech input.

More specifically, the unique role may be the unique role of the second electronic device 200 solely assigned to the second electronic device 200 among the plurality of electronic devices 100, 200, 300 and 400. Accordingly, when the intent corresponds to the unique role of the second electronic device 200, the processor of the first electronic device 100 may determine the second electronic device 200 as the device which will perform the function corresponding to the speech input.

In addition, when the device which will perform the function corresponding to the speech input is the second electronic device 200 among the first electronic device 100 and the one or more other electronic devices 200 and 300, the processor of the first electronic device 100 may transmit a function performing command to the second electronic device 200 (S755).

In this case, the processor of the second electronic device 200 may receive the function performing command and perform the function corresponding to the speech input (S760).

Specifically, the processor of the second electronic device 200 may acquire the intent corresponding to the speech input using the speech input received by the second electronic device 200. In addition, when the function performing command is received, the processor of the second electronic device 200 may perform the function corresponding to the intent.

On the other hand, acquisition of the intent may be performed only by the first electronic device. In this case, the processor of the first electronic device 100 may transmit the intent acquired by the first electronic device 100 to the second electronic device 200 along with the function performing command. In this case, the second electronic device 200 may perform the function corresponding to the intent.

For example, when the second electronic device 200 is a TV and the intent is “Decrease the volume”, the processor of the second electronic device 200 may control the speaker to decrease the volume.

In another example, when the second electronic device 200 is an air conditioner and the intent is “Decrease the temperature”, the processor of the second electronic device 200 may control an outdoor unit and an indoor unit to decrease the discharge temperature of the air conditioner.

Meanwhile, when the intent corresponds to the common role, the processor of the first electronic device 100 may determine the device which will perform the function corresponding to the speech input from among the first electronic device 100 and the one or more other electronic devices 200 and 300

In addition, the processor of the first electronic device 100 may determine the second electronic device 200 closest to the user among the first electronic device 100 and the one or more other electronic devices 200 and 300 as the device which will perform the function corresponding to the speech input.

In this case, the processor of the first electronic device 100 may transmit the function performing command to the second electronic device 200 (S755), and the processor of the second electronic device 200 may perform the function corresponding to the speech input.

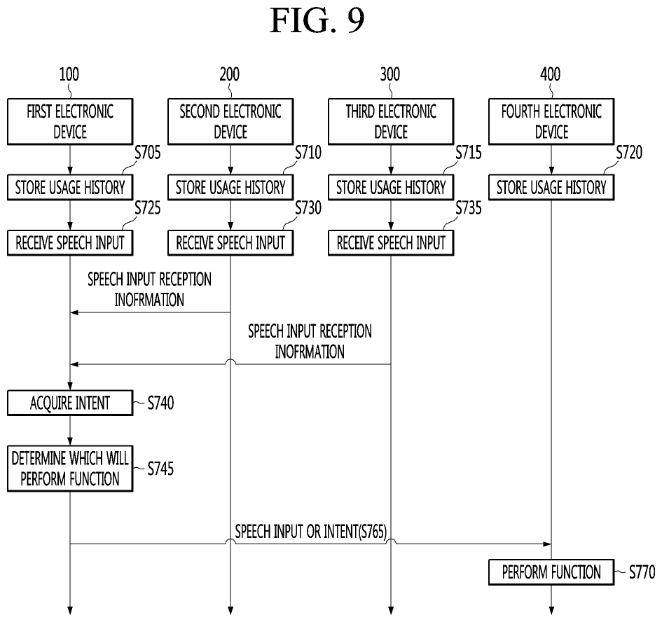

Meanwhile, operation when the speech input corresponds to the unique role of another electronic device but the electronic device does not receive the speech input will be described with reference to FIG. 9.

FIG. 9 is a view illustrating an operation method when speech input corresponds to a unique role of another electronic device but the other electronic device does not receive speech input according to an embodiment of the present invention.

Assume that the device which will perform the function corresponding to the speech input is the fourth electronic device 400. However, the description of the fourth electronic device 400 is applicable to the other electronic devices.

In addition, the same portion as the above description will be omitted and a portions different from the above description will be described with reference to FIG. 9.

The processor of the first electronic device 100 may determine the device which will perform the function corresponding to the speech input, based on the acquired intent and “the first electronic device 100 and the one or more other electronic devices 200 and 300 which have received the speech input (S745).

In addition, the processor of the first electronic device 100 may determine that the device which will perform the function corresponding to the speech input is the fourth electronic device 400, when the intent corresponds to the role of the fourth electronic device 400.

Specifically, when the intent corresponds to the unique role of the fourth electronic device 400, the processor of the first electronic device 100 may determine the fourth electronic device 400 as the device which will perform the function corresponding to the speech input.

Meanwhile, the processor of the first electronic device 100 may determine whether the fourth electronic device 400 which will perform the function corresponding to the speech input has received the speech input. Specifically, when speech input reception information is not received from the fourth electronic device 400, the processor of the first electronic device 100 may determine that the fourth electronic device 400 has not received the speech input.

Meanwhile, when the intent corresponds to the unique role of the fourth electronic device 400 which has not received the speech input, the processor of the first electronic device 100 may transmit the intent or the speech input to the fourth electronic device 400 (S765)

In this case, the processor of the fourth electronic device 400 may receive the intent or the speech input and perform the function corresponding to the speech input (S770).

When the speech input is received from the first electronic device, the processor of the fourth electronic device 400 may acquire the intent corresponding to the speech input using the speech input received from the first electronic device 100. In addition, the processor of the fourth electronic device 400 may perform the function corresponding to the intent. In this case, the fourth electronic device 400 may receive the context information along with the speech input and acquire the intent using the speech input and the context information.

In addition, when the intent is received from the first electronic device, the processor of the fourth electronic device 400 may perform the function corresponding to the intent.

As described above, when the plurality of electronic devices receives the speech input of the user, the plurality of electronic devices may simultaneously perform the function. For example, when the first to third electronic devices 100, 200 and 300 of the plurality of electronic devices 100, 200, 300, 400 and 500 receive the speech input “Let me know today's weather”, the first to fourth electronic devices 100, 200, 300 and 400 output a response to the user's inquiry (for example, today's weather in Seoul is sunny and a temperature is 26° C.)

According to the present invention, since one electronic device performs the common role, it is possible to prevent the plurality of devices from simultaneously performing the function.

In addition, the plurality of electronic devices may receive the speech input of the user but the speech input may correspond to a specific electronic device.

For example, when the user utters speech “How much cooking time is left?”, a cooking device which has received the speech input outputs a response “20 minutes are left”. However, when the TV receives the speech “How much cooking time is left?”, the TV fails to recognize the speech and thus output a response “This is a function that I cannot perform.

In another example, when the user utters speech “Decrease the temperature of the air conditioner”, the air conditioner which has received the speech input performs operation of decreasing the temperature of the air conditioner. However, when the TV receives the speech input “Decrease the temperature of the air conditioner”, the TV fails to recognize the speech and thus output a response “This is a function that I cannot perform.

However, according to the present invention, since the electronic device having the unique role corresponding to the speech input performs the function corresponding to the speech input, the above-described problems can be solved. For example, when “How much cooking time is left?” is uttered, only the cooking device which has received the speech input may output the response “20 minutes are left”.

In addition, the present invention, even when the electronic device which will perform the function corresponding to the speech input has not received the speech input, it is possible to perform the function. For example, when the user utters speech “How much cooking time is left?” and even the cooking device does not receive the speech input, the cooking device may output the response to the remaining cooking time.

Meanwhile, in the above-described embodiment, analysis of the intent is performed by the first electronic device 100. That is, the first electronic device 100 is a master device, and, when the plurality of electronic devices including the first electronic device 100 receives the speech input, the first electronic device 100 may acquire the intent of the user.

However, the present invention is not limited thereto and the device for analyzing the intent may vary according to situations.

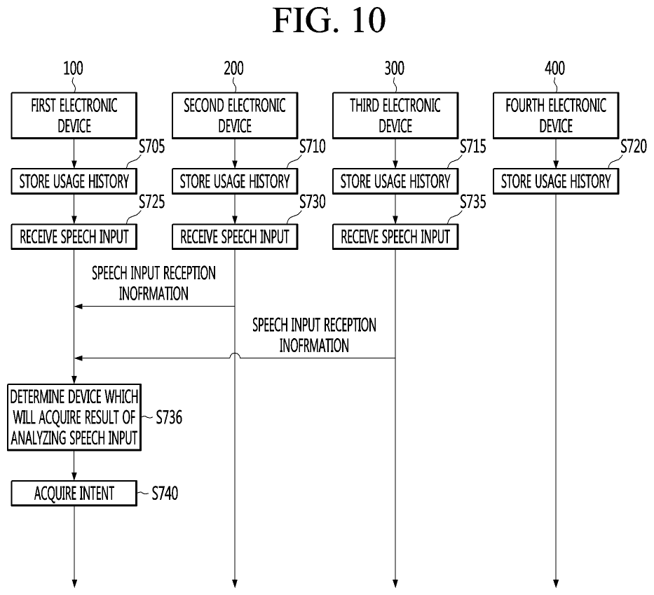

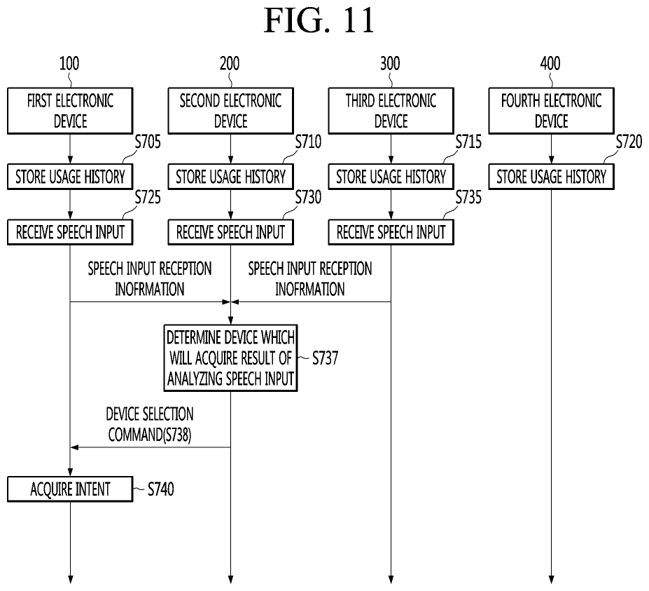

This will be described with reference to FIGS. 10 and 11.

FIG. 10 is a view illustrating a method of determining a device which will acquire an intent.

In addition, the same portion as the above description will be omitted and a portions different from the above description will be described with reference to FIG. 10.

In FIG. 10, assume that the first electronic device 100 selects a device which will acquire the result of analyzing the speech input.

The processor of the first electronic device 100 may receive speech input reception information from the one or more other electronic devices 200 and 300, and determine a device which will acquire the intent from among the first electronic device 100 and the one or more other electronic devices 200 and 300 (S736).

Specifically, the processor of the first electronic device 100 may determine the device which will acquire the intent according to various criteria.

For example, the processor of the first electronic device 100 may determine a device closest to the user from among the first electronic device 100 and the one or more other electronic devices 200 and 300, as the device which will acquire the intent.

In another example, the processor of the first electronic device 100 may determine a device capable of analyzing the intent at a highest speed from among the first electronic device 100 and the one or more other electronic devices 200 and 300, as the device which will acquire the intent.

In another example, the processor of the first electronic device 100 may determine a device capable of receiving the loudest speech input from among the first electronic device 100 and the one or more other electronic devices 200 and 300, as the device which will acquire the intent.

In addition, when the device which will acquire the intent is the first electronic device 100, the processor of the first electronic device 100 may acquire the intent. Specifically, the processor of the first electronic device 100 may acquire the intent corresponding to the speech input using the speech input (or the speech input and the context information).

Then, the processor of the first electronic device 100 may determine the device which will perform the function corresponding to the speech input, based on the intent and “the role set in each of the first electronic device 100 and the one or more other artificial intelligence electronic devices 200 and 300”.

FIG. 11 is a view illustrating another method of determining a device which will acquire an intent.

In addition, the same portion as the above description will be omitted and a portions different from the above description will be described with reference to FIG. 11.

In addition, in FIG. 11, assume that the second electronic device 200 selects a device which will acquire the result of analyzing the speech input.

The processor of the second electronic device 200 may receive speech input reception information from one or more other electronic devices 100 and 300 and determine the device which will acquire the intent from among the second electronic device 200 and one or more other electronic devices 100 and 300 (S738).

In addition, when the device which will acquire the intent is the first electronic device 100, the processor of the second electronic device 200 may transmit a device selection command for selecting a device to the first electronic device 100.

Meanwhile, the processor of the first electronic device 100 may receive the device selection command. In addition, when the device selection command is received from the second electronic device 200, the processor of the first electronic device 100 may acquire the intent (S740).

Then, the processor of the first electronic device 100 may determine the device which will perform the function corresponding to the speech input, based on the intent and “the role set in each of the first electronic device 100 and the one or more other artificial intelligence electronic devices 200 and 300”.

Then, the processor of the first electronic device 100 may determine the device which will perform the function corresponding to the speech input, based on the intent and “the role set in each of the first electronic device 100 and the one or more other artificial intelligence electronic devices 200 and 300”.

According to the present invention, since one electronic device analyzes the intent using the speech input (or the speech input and the context information), it is possible to prevent a plurality of electronic devices which has received the speech input, that is, the plurality of electronic devices activated by the speech input, from simultaneously performing the function.

The present invention mentioned in the foregoing description can also be embodied as computer readable codes on a computer-readable recording medium. Examples of possible computer-readable mediums include HDD (Hard Disk Drive), SSD (Solid State Disk), SDD (Silicon Disk Drive), ROM, RAM, CD-ROM, a magnetic tape, a floppy disk, an optical data storage device, etc. The computer may include the controller 180 of the terminal. Therefore, the embodiments disclosed in the present invention are to be construed as illustrative and not restrictive. The scope of the present invention should be construed according to the following claims, and all technical ideas within equivalency range of the appended claims should be construed as being included in the scope of the present invention.

What is claimed is:

1. An artificial intelligence electronic device comprising:
an input interface configured to receive speech input from a user;
a communicator configured to communicate with a plurality of other artificial intelligence electronic devices; and
a processor configured to:
determine a device which will perform a function corresponding to the speech input, when the artificial intelligence electronic device and one or more other artificial intelligence electronic devices receive the speech input, and
perform the function corresponding to the speech input when the device which will perform the function corresponding to the speech input is the artificial intelligence electronic device.

2. The artificial intelligence electronic device of claim 1, wherein the processor acquires an intent corresponding to the speech input using the speech input, and determines the device which will perform the function corresponding to the speech input based on the intent and “role set in each of the artificial intelligence electronic device and the one or more other artificial intelligence electronic devices”.

3. The artificial intelligence electronic device of claim 2, wherein the role includes a common role commonly assigned to the plurality of artificial intelligence electronic devices and a unique role solely assigned to one of the plurality of artificial intelligence electronic devices.

4. The artificial intelligence electronic device of claim 3, wherein the common role and the unique role are set in each of the plurality of electronic devices based on usage histories of the plurality of electronic devices.

5. The artificial intelligence electronic device of claim 3, wherein the processor determines the artificial intelligence electronic device as the device which will perform the function corresponding to the speech input, when the intent corresponds to the unique role of the artificial intelligence electronic device.

6. The artificial intelligence electronic device of claim 3, wherein the processor determines the device which will perform the function corresponding to the speech input from among the artificial intelligence electronic device and the one or more other artificial intelligence electronic devices, when the intent corresponds to the common role, and performs the function corresponding to the speech input when the device which will perform the function corresponding to the speech input is the artificial intelligence electronic device.

7. The artificial intelligence electronic device of claim 6, wherein the processor determines, as the device which will perform the function corresponding to the speech input, a device closest to the user among the artificial intelligence electronic device and the one or more other artificial intelligence electronic devices, when the intent corresponds to the common role, and performs the function corresponding to the speech input when the artificial intelligence electronic device is closest to the user.

8. The artificial intelligence electronic device of claim 2, wherein the processor transmits a function performing command to a second artificial intelligence electronic device, when the device which will perform the function corresponding to the speech input is the second artificial intelligence electronic device among the artificial intelligence electronic device and the one or more other artificial intelligence electronic devices.

9. The artificial intelligence electronic device of claim 8, wherein the processor determines, as the device which will perform the function corresponding to the speech input, the second artificial intelligence electronic device closest to the user among the artificial intelligence electronic device and the one or more other artificial intelligence electronic devices, when the intent corresponds to the common role, and transmits a function performing command to the second artificial intelligence electronic device.

10. The artificial intelligence electronic device of claim 8, wherein the processor determines the second artificial intelligence electronic device as the device which will perform the function corresponding to the speech input, when the intent corresponds to a unique role of the second artificial intelligence electronic device, and transmits a function performing command to the second artificial intelligence electronic device.

11. The artificial intelligence electronic device of claim 2, wherein the processor transmits the intent or the speech input to a third artificial intelligence electronic device, when the intent corresponds to a unique role of the third artificial intelligence electronic device which has not received the speech input.

12. The artificial intelligence electronic device of claim 2, wherein the processor:
receives speech input reception information from the one or more other artificial intelligence electronic devices and determines a device which will acquire the intent from among the artificial intelligence electronic device and the one or more other artificial intelligence electronic devices, and
acquires the intent when the device which will acquire the intent is the artificial intelligence electronic device.

13. The artificial intelligence electronic device of claim 2, wherein the processor acquires the intent when a device selection command is received from another artificial intelligence electronic device.
